(19) United States
(12) Patent Application Publication
(10) Pub. No.: US 2008/0314883 A1
(43) Pub. Date: Dec. 25, 2008

(54) Laser Processing Method and Equipment

(76) Inventors: Saulius Juodkazis, Hokkaido (JP); Oleg Efimov, Thousand Oaks, CA (US); Hiroaki Misawa, Hokkaido (JP); Yasuyuki Tsuboi, Hokkaido (JP)

Correspondence Address: THE NATH LAW GROUP, 112 South West Street, Alexandria, VA, 22314, US

(21) Appl. No.: 11/579,697

(22) PCT Filed: Apr. 18, 2005
(86) PCT No.: PCT/JP2005/07403

§ 371 Date: Nov. 6, 2006

(30) Foreign Application Priority Data
May 26, 2004 (JP) 2004-156768

(51) Int. Cl. B23K 26/14

(52) U.S. Cl. 219/121.72; 219/121.67

(57) ABSTRACT

A laser processing method and apparatus capable of forming an extremely minute modified area not exceeding half the diffraction limit value of the laser wavelength used for processing without causing plasma in a processing object such as a dielectric material substrate or semiconductor material substrate. In this technology, attention is paid to the fact that new damage is caused even at laser intensity that does not cause plasma at all, and a laser beam (1) that has lower laser intensity than the laser intensity threshold at which plasma occurs (for example, approximately 1/1.5 of that laser intensity threshold) is convergently radiated into a processing object (10) using an irradiation optical system (20) accuracy-designed so as not to cause a self-focusing effect at the convergence location (3).

### TECHNICAL FIELD

The present invention relates to a laser processing method and apparatus, and more particularly to a laser processing method and apparatus suitable for forming minute damage (modification) in a processing object such as a dielectric material substrate or semiconductor material substrate by means of pulsed laser irradiation, and forming a cutting start area used for cutting of the processing object.

### BACKGROUND ART

Fine processing of materials can be cited as a recent pulsed laser application. It is especially important to shorten the pulse time width of the pulsed laser used in order to make the size of the processing area smaller and more minute. Laser pulse widths common among commercially available products are microsecond (sub-millisecond) (1 ms=10⁻⁶ second), nanosecond (1 ns=10⁻⁹ second), picosecond (1 ps=10⁻¹² second), and femtosecond (1 fs=10⁻¹⁵ second). Generally, as the pulse width of a laser used for processing increases, thermal damage around the processing area becomes more pronounced. Also, with a long laser pulse width it becomes difficult to utilize nonlinear optical effects such as multiphoton absorption. That is to say, as the pulse width of a laser used for processing increases, processing accuracy (processing spatial resolution) declines, and processing finer than the laser wavelength becomes difficult.

In recent years, the establishment of sub-micrometer fine processing technologies typified by nanotechnology has become an urgent matter. Consequently, the use of shorter laser pulses has become one trend in laser processing technology, and, in specific terms, many techniques have been proposed that use a laser with a pulse width of around 100 femtoseconds (=10⁻¹³ second). When a substance is irradiated with such a femtosecond laser, light energy can be injected in concentrated form in an extremely short period of femtoseconds. Therefore, thermal diffusion around the irradiated area can be virtually ignored, and nonlinear effects such as multiphoton absorption can be effectively caused. As a result, in the case of a femtosecond pulsed laser, fine processing of a size not exceeding the wavelength is possible.

The technology described in Patent Document 1 is known as a conventional technology in this kind of femtosecond laser processing. In the technology described in Patent Document 1, pulsed laser irradiation is performed with a metal such as gold or a dielectric material such as glass as the object, and the dependence of the fluence (J/cm²) threshold (Fₜₕ) at which damage (Laser Induced Breakdown: LIB) is induced on the laser pulse width (τ), is investigated. Damage is mainly confirmed by monitoring the plasma radiation intensity. That is to say, damage in the technology described in Patent Document 1 is mainly a plasma generated type of damage. The term “plasma” here is virtually synonymous with “ionization,” “dielectric breakdown,” “avalanche ionization,” and so forth.

In the technology described in Patent Document 1, in a region in which pulse width τ is long (in the case of glass, τ>10 picoseconds), a scaling rule whereby threshold Fₜₕ is proportional to the square root of τ (Fₜₕ∝√τ) is observed. On the other hand, if pulse width τ becomes shorter than this, the curve of the plot is observed to abruptly vary or deviate from the scaling rule. If material is laser-irradiated in a region with a short pulse width deviating from the scaling rule, a cavity (void) smaller than the laser wavelength in size is formed. For example, if glass is the processing object, the laser wavelength is 800 nm, and the laser pulse width is 150 femtoseconds, damage threshold Fₜₕ is a large value of 30 J/cm², and it is pointed out that this large Fₜₕ value coincides with multiphoton avalanche theory. That is to say, damage induced in glass is plasma generation due to a multiphoton avalanche ionization, but a concrete value relating to the size of the caused damage is not shown.

For the technology described in Patent Document 1, implementation examples are shown for cases in which a metal such as gold, or biological tissue, is the processing object, as well as glass. For all of these, it is pointed out that “processing accuracy improves in a region with a short pulse width deviating from the scaling rule.” That is to say, with “damage” as defined in the technology described in Patent Document 1, regarding the dependence of the fluence threshold (Fₜₕ) on the laser pulse width (τ), the Fₜₕ∝√τ scaling rule holds true in all cases in a long pulse width region, and if the pulse width is shorter than a certain value, the threshold (Fₜₕ) is larger than the value predicted from this scaling rule. The technology described in Patent Document 1 identifies an improvement in processing accuracy only for “damage” showing this behavior. Patent Document 1: International Pamphlet Publication No. 95/27587

### DISCLOSURE OF INVENTION

### Problems to be Solved by the Invention

However, in the technology described in Patent Document 1, with a dielectric material such as glass, in particular, the mechanism that induces damage is plasma generation due to a multiphoton avalanche ionization. As stated above, in the technology described in Patent Document 1, with a short pulse width that deviates from the Fₜₕ∝√τ scaling rule, damage threshold fluence Fₜₕ does not decrease in accordance with a decrease in the pulse width, but (deviates from the scaling rule and) increases. That is to say, high fluence is necessary in order to induce damage, and with such high fluence, it is due precisely to plasma generation that damage is induced.

In plasma generation, the temperature at an irradiated area momentarily reaches tens of thousands of degrees [K], and a large number of free electrons having high kinetic energy are produced. Therefore, not only is the atomic structure completely destroyed at the irradiation location, but the size of the damaged area also becomes large because of thermal diffusion due to the great rise in temperature. Furthermore, free electrons with high kinetic energy are diffused randomly, damage is induced, and this effect also contributes to increasing the size of damage. That is to say, plasma occurrence is not desirable from the standpoint of reducing the size of damage—that is, the fineness of processing. In processing by means of such plasma occurrence, although it may be possible for the size of damage to be smaller than the laser wavelength, fine processing on the order of not more than half the laser wavelength diffraction limit value (roughly 0.6 times laser wavelength λ) is impossible.

It is therefore an object of the present invention to provide a laser processing method and apparatus that are capable of causing damage (modification) smaller than the diffraction limit value of the laser wavelength in an irradiated area, without causing plasma, by means of laser pulse irradiation of a semiconductor material or a dielectric material such as glass.

### Means for Solving the Problem

The present invention performs convergent irradiation, via an optical system, of a processing object with a laser beam that has laser intensity smaller than a laser intensity threshold at which plasma is caused in the processing object, and causes damage in the processing object without causing plasma therein.

### ADVANTAGEOUS EFFECT OF THE INVENTION

The present invention enables a laser processing method and apparatus to be obtained that can cause damage (modification) smaller than the diffraction limit value of the laser wavelength, without causing plasma, for various kinds of dielectric material and semiconductor material.

### BRIEF DESCRIPTION OF DRAWINGS

FIG. 1 is a block diagram showing the configuration of a laser processing apparatus according to one embodiment of the present invention;

FIG. 2 is a flowchart showing the procedure of processing using the laser processing apparatus in FIG. 1;

FIG. 3A is a graph showing simulation results of the dependence of the laser beam cross-sectional direction damage size (diameter) on laser intensity in glass (refractive index n=1.515);

FIG. 3B is a graph showing simulation results of the dependence of the laser beam optical axis direction damage size (length) on laser intensity in the same glass;

FIG. 4A is a drawing showing a light scattering image of damage according to the present invention;

FIG. 4B is a drawing showing an image of plasma emission;

FIG. 5A is a graph showing the dependence of laser intensity (irradiance) threshold of the damage according to the present invention on the pulse width;

FIG. 5B is a graph showing the dependence of laser intensity (irradiance) threshold of the damage according to the technology described in Patent Document 1 on the pulse width;

FIG. 6 is a graph showing the dependence of laser intensity (fluence) threshold of the damage according to the present invention on the pulse width;

FIG. 7 is a drawing showing schematically structural change induced by damage according to the present invention in glass, with FIG. 7A showing the structure of glass before laser irradiation, and FIG. 7B showing the structure of glass after laser irradiation; and

FIG. 8 is a drawing showing the measurement result of laser intensity thresholds of the damage according to the present invention for various processing objects.

### BEST MODE FOR CARRYING OUT THE INVENTION

An embodiment of the present invention will now be described in detail with reference to the accompanying drawings.

The present inventors converged various kinds of pulsed laser inside dielectric materials such as glass via an optical system including an objective lens, and at the same time carried out observation of laser scattering image enlargement of the irradiated area. As a result, it was found that, as laser intensity was gradually lowered from the fluence threshold at which plasma is caused, new damage is caused even by fluence that does not cause such a plasma at all as in the technology described in Patent Document 1. Based on this completely new damage phenomenon, the present inventors conceived the invention of the present application described in detail below.

The present invention relates to a method and apparatus that execute processing finer than the diffraction limit value on a processing object, and monitor that processing area. With the present invention, pulsed laser light is converged by means of an irradiation optical system optimized for definition, and at the same time the irradiated area is subject to image measurement by means of a dark field laser beam scattering method, and the presence or absence of damage is accurately measured. An essential point included in the irradiation optical system design policy is the provision of measures to prevent the occurrence of a self-focusing effect at the convergence location. Also, by measuring variation of the convergence location in pulsed laser irradiation, plasma is not caused at the convergence location, and damage of fineness totally different from damage due to plasma is caused at lower light energy than that for causing plasma.

As described above, damage according to the present invention differs fundamentally from plasma induced damage according to the technology described in Patent Document 1. This can easily be understood from the following observed facts. The fluence threshold of the damage according to the present invention is determined for various materials by means of a laser beam scattering image measurement method described later herein. As a result, when the processing object is glass, the fluence threshold of the damage according to the present invention was found to be approximately 1/1.5 the value of the plasma induction threshold. Furthermore, with glass as the processing object, for example, the dependence of the damage threshold of the invention of the present application on the laser pulse width was investigated in the same way as for the technology described in Patent Document 1. As a result, it was found that, when the laser pulse width was varied over a wide range from 150 femtoseconds to 30 nanoseconds, the damage threshold monotonically decreases linearly in accordance with a decrease in the laser pulse width. That is to say, Fₜₕ∝√τ holds true for damage according to the present invention. This is clearly different behavior from the Fₜₕ∝√τ scaling rule of the technology described in Patent Document 1, and shows that damage according to the present invention is caused by a completely different mechanism from that of the technology described in Patent Document 1.

The above-described behavior is observed when laser intensity is indicated by fluence. “Fluence” is light energy per unit area, and is expressed in [J/cm²] units. An other definition of laser intensity is a quantity called “irradiance” which indicates light energy radiated per unit area and unit time, and is expressed in [W/cm²] units. Thus, the above-described Fₜₕ∝τ dependency was rewritten using the irradiance threshold. That is to say, the dependence of the damage irradiance threshold (Iₜₕ) on the laser pulse width (τ) according to the present invention was investigated. As a result, very different behavior was observed whereby the irradiance threshold is not dependent on the pulse width at all, and a fixed value is obtained (Iₜₕ=fixed). The present invention causes damage in accordance with this behavior.

A preferred embodiment of the present invention will now be described in detail with reference to the accompanying drawings.

Materials used as objects of processing in the present invention are dielectric or semiconductor materials such as glass, alkali halide (calcium fluoride, etc.), sapphire, and diamond. The pulsed laser wavelength (λ) used corresponds to light energy lower than the band gaps of these materials—more specifically, corresponding to visible light of approximately 500 nm to near infrared light of approximately 1 to 2 μm. Pulsed lasers supplying pulse light of such wavelengths that can be used include, for example, a 10 to 500 femtosecond pulse width femtosecond pulse oscillation titanium sapphire laser (λ to 800 nm) and harmonics thereof (λ to 400 nm), an approximately 10 picosecond pulse width picosecond pulse oscillation titanium sapphire laser (λ to 800 nm) and harmonics thereof (λ to 400 nm), a 10 to 30 picosecond pulse width picosecond Nd:YAG laser (λ=1064 nm) and harmonics thereof (λ=532 nm or 355 nm), and an approximately 10 nanosecond pulse width nanosecond pulse oscillation Nd:YAG laser (λ=1064 nm) and harmonics thereof (λ=532 nm or 355 nm). To improve the fineness of damage, use of a femtosecond pulsed laser is desirable. Although there is no particular limit on the repeat oscillation frequency of pulse oscillation (the number of pulse supplies per unit time) since damage according to the present invention can be formed with single-shot irradiation, a high repeat oscillation state is desirable in order to cause a large number of damages in the processing object at high speed, and in specific terms, a 1 kHz (kilohertz) oscillation femtosecond titanium sapphire laser or the like is used, for example.

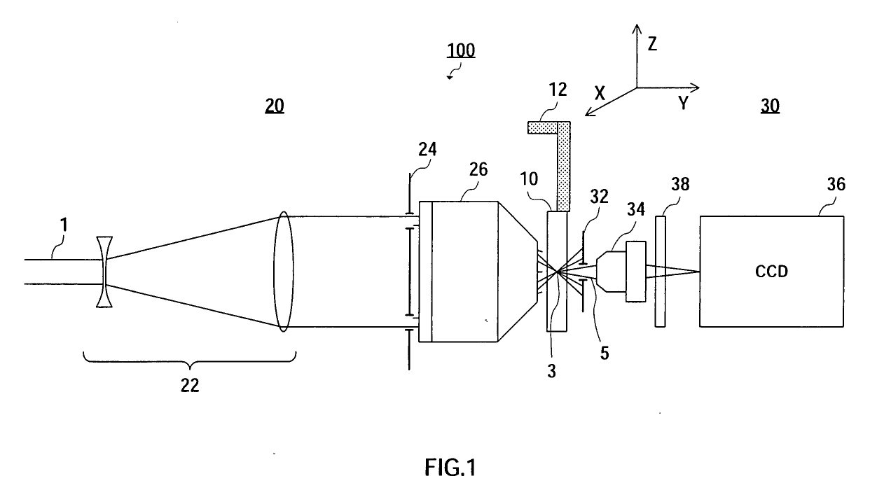

FIG. 1 is a block diagram showing the configuration of a laser processing apparatus according to one embodiment of the present invention.

This laser processing apparatus 100 is an apparatus that induces above-described damage according to the present invention and simultaneously confirms that damage, and has an irradiation optical system 20 that induces damage according to the present invention in a processing object 10, and a laser beam scattering image measurement optical system 30 for observing damage. Processing object 10 is fixed to a three-dimensional stage 12, and can be arbitrarily scan-driven three-dimensionally so that processing is performed at a predetermined location.

Irradiation optical system 20 narrows down laser light to the light diffraction limit within processing object 10, and is designed to prevent a self-focusing effect. Irradiation optical system 20 has a telescopic optical system 22, a diaphragm 24, and an objective lens 26. A laser beam 1 generated by a laser light source (not shown) has its beam diameter enlarged by a predetermined factor (for example, approximately 3-fold) by telescopic optical system 22. Specifically, for example, the diameter of laser beam 1 is enlarged from 6 mm to a maximum of 20 mm by telescopic optical system 22. After its beam diameter has been enlarged, laser beam 1 passes through diaphragm 24, and the beam is shaped so as to have a ring-shaped cross-section. The reason for forming a ring-shaped beam will be explained later herein. The diameter of the ring is 8 to 10 mm, for example. After undergoing beam shaping, laser beam 1 is converged at a predetermined convergence location 3 inside processing object 10 by an oil-immersion objective lens 26 that has a high numerical aperture (NA) value. Specifically, the numerical aperture (NA) of objective lens 26 is 1.0 or above, for example. In actuality, diaphragm 24 and objective lens 26 are used incorporated into an optical microscope. By means of this optical arrangement, laser beam 1 forms a large solid angle and is converged inside processing object 10. As a result, extension of the beam spot due to a self-focusing effect is not caused at convergence location 3, and the beam spot diameter at convergence location 3 can be converged to approximately the laser beam 1 diffraction limit value (roughly λ×0.6).

On the other hand, laser beam scattering image measurement optical system 30 for confirming the damage caused is located on the side opposite laser irradiation. Laser beam 1 converged inside processing object 10 as described above in order to cause damage is scattered due to the damage caused by itself, and minute damage can therefore be confirmed by dark field enlarged image measurement of this scattered light. The reason such a method is necessary to confirm damage is that damage according to the present invention is not cavity-shaped damage (cracks and holes) due to plasma according to the technology described in Patent Document 1, but damage such that the density and refractive index of the irradiated area vary, which is difficult to confirm with a simple optical microscope.

Laser beam scattering image measurement optical system 30 has a spot screen (aperture) 32, an objective lens 34, a CCD camera 36, and an optical filter 38. Laser beam 1 that has a ring-shaped beam cross-section and has been converged inside processing object 10 in order to cause damage, as described above, diverges again while having a ring-shaped beam cross-section, and is blocked by spot screen 32 after emerging from processing object 10. However, when damage has been caused at convergence location 3, part of incident laser beam 1 is scattered due to the damage at convergence location 3, and the optical path (direction of travel) changes. As a result, scattered light 5 can pass through spot screen 32. Then, scattered light 5 passes through objective lens 34 and is magnified, and a scattering image is picked up by CCD camera 36. That is to say, when damage according to the present invention is not caused, the scattering image is a completely dark field, and only when damage is induced does a scattering image appear on the CCD screen, enabling the occurrence of damage to be confirmed. Also, when plasma is caused by laser irradiation as in the technology described in Patent Document 1, it is also possible to locate an optical filter 38 that cuts only the laser wavelength on the front surface of CCD camera 36 and cut scattered light 5, enabling only plasma emission to be picked up.

The irradiation condition (fluence threshold) that enables damage according to the present invention to be caused in processing object 10 is determined by laser beam scattering image measurement optical system 30. The determined irradiation condition is fed back immediately in the irradiation procedure, and the laser light source (not shown) is adjusted so that the laser output becomes the determined output. As described above, processing object 10 is fixed to three-dimensional stage 12, and can be arbitrarily scan-driven three-dimensionally so that processing is performed at a predetermined location. As described above, laser beam 1 is converged to processing object 10 using irradiation optical system 20, enabling processing to be performed at a predetermined location.

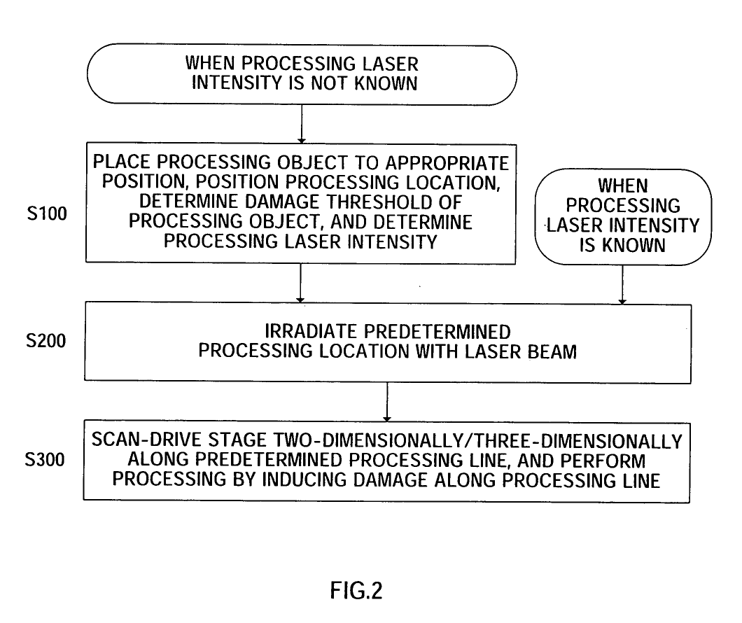

FIG. 2 is a flowchart showing the procedure of processing using laser processing apparatus 100 in FIG. 1. As shown in FIG. 2, the processing procedure differs according to whether or not the processing laser intensity is known.

When the processing laser intensity is not known, after processing object 10 is placed on three-dimensional stage 12 and the processing location is positioned, processing object 10 is irradiated by laser beam 1, and the damage threshold of processing object 10 is determined, and the processing laser intensity is determined, by laser beam scattering image measurement optical system 30 (step S100). Then the predetermined processing location is irradiated by laser beam 1 via irradiation optical system 20 at the laser intensity determined in step S100 (step S200). Three-dimensional stage 12 is then scan-driven two-dimensionally or three-dimensionally along a predetermined processing line, damage is induced along the predetermined processing line, and the desired processing is performed (step S300).

When the processing laser intensity is known, the procedure in step S100 is not necessary, and the procedures in step S200 and step S300 are carried out directly.

Here, the size of damage according to the present invention caused by the above-described method (the vertical direction dimension with respect to the laser optical axis) can be calculated by means of the following numerical calculations. For a laser beam used in the present invention, light intensity distribution in a vertical direction with respect to the direction of travel of that laser beam (that is, beam cross-sectional intensity distribution) is expressed by a Gaussian function, and such a light beam is called a Gaussian beam. When such a Gaussian beam is converged in a processing object by an objective lens, light intensity distribution I(r, z) and beam convergence spot size radius w(z) at the convergence location are expressed as shown in Equation 1 and Equation 2 below respectively.

### [Numeral Expression 1]

$$I ( r , z ) = {I}_{0} \frac{{w}_{0}^{2}}{{w ( z )}^{2}} {e}^{- 2 {( \frac{r}{w ( z )} )}^{2}} \qquad ( Equation 1 )$$

### [Numeral Expression 2]

$$w ( z ) = \sqrt{\frac{λ}{n π} ( {z}_{R} + \frac{{z}^{2}}{{z}_{R}^{2}} )} ≡ {w}_{0} \sqrt{1 + {( \frac{z λ}{{w}_{0}^{2} n π} )}^{2}} \qquad ( Equation 2 )$$

Here, r is the beam cross-sectional direction coordinate (r=0 at the center of the beam), z is the beam direction-of-travel coordinate (z=0 at the convergence location), n is the refractive index of the processing object, and λ is the laser wavelength in vacuo, I₀ is the light intensity at the center of the beam at the convergence location (r=z=0), and w₀ is the beam convergence spot size at the convergence location (z=0, referred to at this location as “beam waist”). In Equation 2, z_{R} is called the Rayleigh length, and is expressed as shown in following Equation 3.

### [Numeral Expression 3]

$${z}_{R} = \frac{n π {w}_{0}}{λ} \qquad ( Equation 3 )$$

From Equation 1, light intensity I around the convergence spot (r=z₀) in the beam waist (z=0) diminishes from center part I₀ in accordance with the relationship of I=I₀/e². On the other hand, conventionally, beam convergence spot size diameter d is considered as Full Width at Half Maximum (FWHM). That is to say, laser beam cross-sectional direction damage diameter D is defined as the diameter of the convergence spot where cross-sectional direction beam light intensity I is half of beam center light intensity I₀ (I=I₀/2). In other words, the beam spot size is considered at a location where the light intensity diminishes to I=I₀/e² with respect to center part intensity, or a location where this diminishes to I=I₀/e², but in practice, the latter (FWHM definition) is considered, and in this case, d according to the latter definition is 2/√2In(2)=1.699 smaller than according to the former definition (becoming 1/1.699). On the other hand, in the direction of travel of the beam, the location at which this light intensity becomes half is Z=z_{R}. Based on the above, the size of damage according to the present invention can be calculated.

That is to say, with regard to damage at light intensity I₀ of damage threshold Iₜₕ or above, applying I(r, z)=Iₜₕ in Equation 1, laser beam cross-sectional direction size (diameter) D and laser beam optical axis direction size (length) L of damage according to the present invention can be expressed as shown in following Equation 4 and Equation 5 respectively.

### [Numeral Expression 4]

$$D = {w}_{0} \sqrt{2 ln ( \frac{{I}_{0}}{{I}_{th}} )} \qquad ( Equation 4 )$$

### [Numeral Expression 5]

$$L = 2 {z}_{R} \sqrt{\frac{{I}_{0}}{{I}_{th}} - 1} \qquad ( Equation 5 )$$

Here, if the numerical aperture of the objective lens used is designated NA, convergence spot size w₀ in the beam waist (z=0) can be expressed approximately by following Equation 6.

### [Numeral Expression 6]

$${w}_{0} = \frac{λ}{π N A} \qquad ( Equation 6 )$$

Thus, using Equation 4 and Equation 5, laser beam cross-sectional direction diameter D and laser beam optical axis direction length L of damage can be calculated.

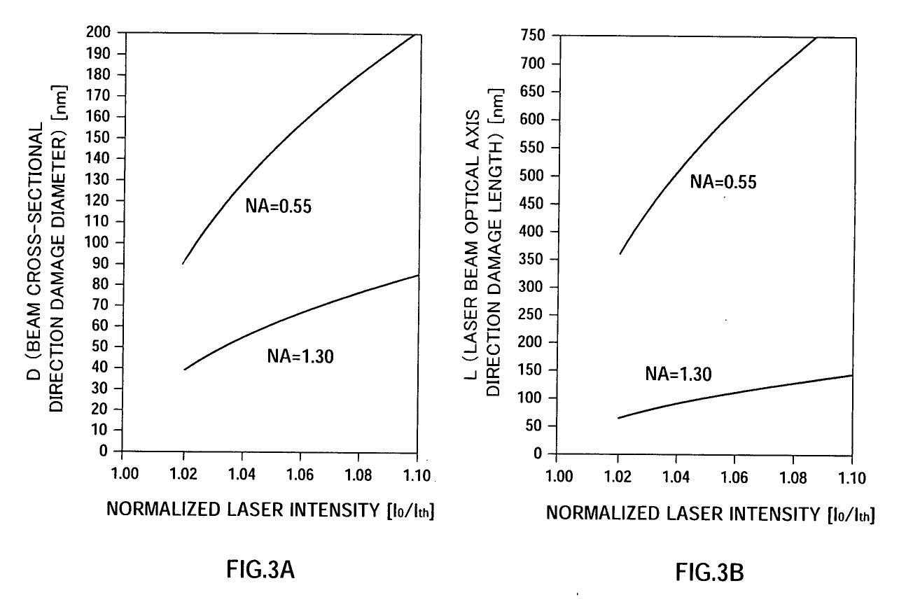

Based on the above-described theory (Equation 4 and Equation 5), the present inventors performed simulation calculation for silicate glass (refractive index n=1.515) of the dependence of damage size (above-described D and L) on laser intensity when an 800 nm wavelength laser beam is converged. FIG. 3 shows the simulation results. FIG. 3A shows simulation results of damage diameter D in laser beam cross-sectional direction, and FIG. 3B shows simulation results of damage length L in laser beam optical axis direction. Here, both FIG. 3A and FIG. 3B show simulation results when using two different objective lenses (NA=0.55 and NA=1.30). In these figures, the horizontal axis is scaled with values in which laser intensity I₀ is normalized with damage threshold Iₜₕ (I₀/Iₜₕ). That is to say, laser intensity values on the horizontal axis are normalized with the damage threshold.

From FIG. 3A, with regard to damage laser beam cross-sectional direction diameter D, it is easily recognized that damage diameter D increases as the laser intensity increases. The point to be noted here is the size. With an objective lens numerical aperture of 0.55 (NA=0.55), when laser intensity I reaches 1.10 times threshold Iₜₕ, diameter D increases, yet only up to approximately 200 nm. Furthermore, when an objective lens with a numerical aperture (NA) of 1.30 is used, diameter D can be made 100 nm or less. Also, from FIG. 3B, with regard to damage laser beam optical axis direction length L, it can be seen that, with a numerical aperture (NA) of 0.55, when laser intensity I reaches 1.10 times threshold Iₜₕ, L reaches the laser wavelength (800 nm). However, when the numerical aperture of the objective lens is increased to a value of NA=1.30, damage length L can be decreased to 150 nm or less. Thus, by increasing the numerical aperture (NA) of the objective lens used (such that NA>1, for example), the size of damage can be decreased to less than half the laser wavelength diffraction limit.

Thus, according to this embodiment, convergent irradiation of a processing object with a laser beam that has lower laser intensity than the laser intensity threshold at which plasma occurs (for example, approximately 1/1.5 of that laser intensity threshold) is performed using a reduced projection optical system accuracy-designed so as not to cause a self-focusing effect at the convergence location, enabling an extremely minute modified area to be formed that does not exceed half the diffraction limit value of the laser wavelength used for processing, without causing plasma inside a processing object such as a dielectric material substrate or semiconductor material substrate.

Such a minute modified area is difficult to confirm with normal methods, but, as described above, by using a dark field light scattering observation method, a place where modification has been performed can clearly be identified, and appropriate fine processing can be carried out at a desired location.

The present inventors also conducted experiments to demonstrate the present invention.

### EXPERIMENT 1

In Experiment 1, silicate glass (trademark name: BK7) was used as the processing object, and a femtosecond titanium sapphire laser (800 nm wavelength, 150 fs pulse width) was used as the processing laser. It was confirmed that laser beam 1 could be converged to a spot with a diameter of 550 nm, almost equal to the diffraction limit value (800 nm×0.6=480 nm), by the apparatus in FIG. 1. This value was confirmed by a surface convergence control experiment, atomic force microscope (AFM) observation, and numerical simulation.

Subsequently, damage was all caused by single-shot laser pulse irradiation for one place.

### EXPERIMENT 2

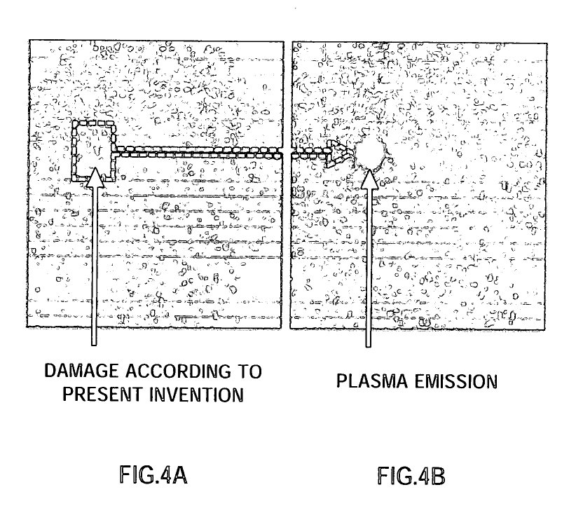

In Experiment 2, the dependence of glass femtosecond pulse damage on laser intensity was investigated in the same way as in Experiment 1. That is to say, silicate glass (trademark name: BK7) was used as the processing object, and a femtosecond titanium sapphire laser (800 nm wavelength, 150 fs pulse width) was used as the laser. FIG. 4 shows typical examples of dark field scattering images at the laser irradiation location in this case. FIG. 4A shows a light scattering image of damage according to the present invention induced by fluence F of 1.45 J/cm² (irradiance I of 6.6 TW/cm²), and FIG. 4B shows an image of plasma emission induced by fluence F of 2.1 J/cm² (irradiance I of 9.4 TW/cm²).

That is to say, when irradiance I in the irradiated area reached threshold I^{P}ₜₕ=9.8 TW/cm², spark-shaped visible light emission was observed in the irradiated area (see FIG. 4B). This is plasma occurrence due to laser convergence of the kind also observed in the technology described in Patent Document 1. Next, when the laser intensity was lowered below threshold I^{P}ₜₕ, and the irradiated area was observed in detail by means of a light scattering image, laser beam scattering image was observed in which plasma was not caused even at irradiance threshold I^{d}ₜₕ=6.6 TW/cm², 1/1.5 of plasma generation threshold I^{P}ₜₕ, as shown in FIG. 4A, and it could be confirmed that damage was caused. At this threshold, light energy per pulse was 40 nJ. Estimating the size of this damage by means of the above-described numerical simulation and atomic force microscope (AFM), the damage size was found to be 100 to 200 nm, far smaller than the diffraction limit value of the laser wavelength used (800 nm×0.6=480 nm).

It was thus demonstrated that, according to the present invention, it is possible to induce damage of a size far smaller than the laser wavelength diffraction limit value (half of the diffraction limit value or less) without causing plasma.

### EXPERIMENT 3

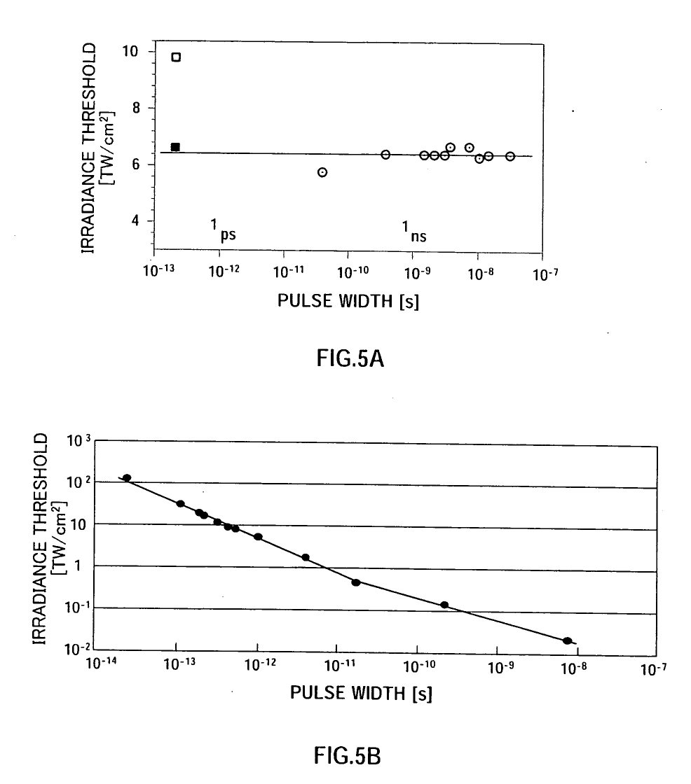

In Experiment 3, the dependence of the threshold of damage laser intensity (irradiance) according to the present invention on the pulse width was investigated for glass (BK7 glass, for example). The pulsed lasers used were a femtosecond titanium sapphire laser (800 nm wavelength, 150 fs pulse width), a picosecond Nd:YAG laser (1064 nm wavelength, 30 ps pulse width), a nanosecond Nd:YAG laser (1064 nm wavelength, 10 ns pulse width), and so forth. As a result, it was found that damage irradiance threshold I^{d}ₜₕ maintained an almost fixed value of 6 TW/cm² over a wide range of pulse widths from 100 femtoseconds to 30 nanoseconds, as shown in FIG. 5A. That is to say, it was found that damage irradiance threshold I^{d}ₜₕ is not at all dependent on pulse width τ of the pulsed laser used, but has an almost fixed value. This is an important experimental fact that characterizes damage according to the present invention.

For comparison, in FIG. 5B the dependence of the fluence threshold on pulse width for glass according to the technology described in Patent Document 1 is revised for irradiance. That is to say, FIG. 5B shows the dependence of the damage laser intensity (irradiance) threshold on the pulse width according to the technology described in Patent Document 1.

In both FIG. 5A and FIG. 5B the processing object is glass. Comparing FIG. 5A and FIG. 5B, it is clear that processing is based on a completely different mechanism from that of the technology described in Patent Document 1.

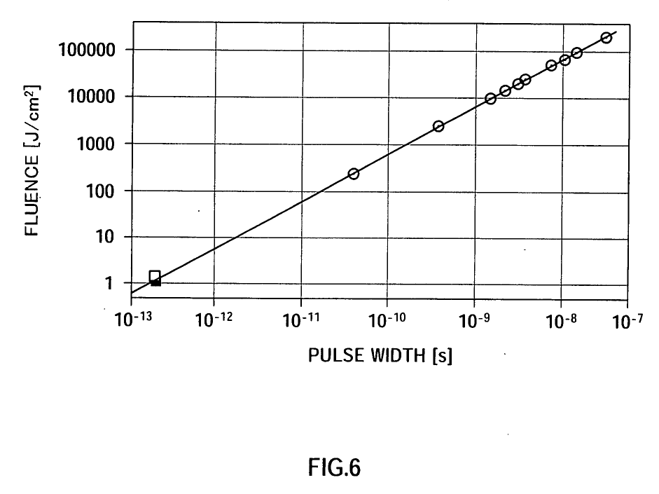

On the other hand, if the threshold of damage according to the present invention is now converted to fluence, and plotted against pulse width, the result is as shown in FIG. 6. It can be seen from FIG. 6 that fluence threshold Fₜₕ decreases monotonically with respect to pulse width τ—that is, satisfies the relationship Fₜₕ∝τ.

That is to say, it was found that, as is clear from FIG. 6, with the present invention the relationship Fₜₕ∝τ holds true to a good degree over the entire range of pulse widths, and the kind of scaling rule that appears in the technology described in Patent Document 1 (Fₜₕ∝√τ) was not observed at all.

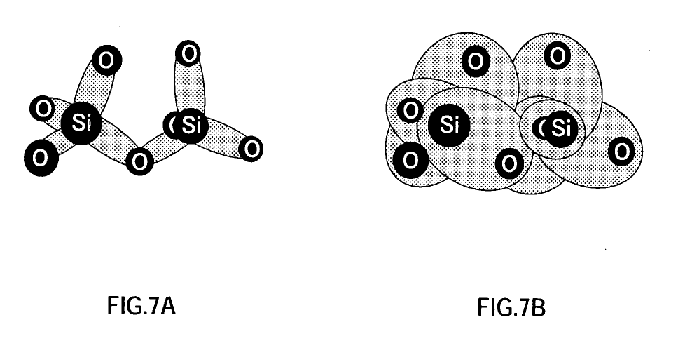

The mechanism of the occurrence of damage according to the present invention will now be described. Damage according to the present invention is not the kind of cavity-shaped damage due to plasma generation according to the technology described in Patent Document 1, but is damage characterized by density modification or refractive index modification. As described above, this damage is independent of the pulse width value, and is a phenomenon induced when light energy per unit time and unit area (that is, irradiance) reaches a fixed value I^{d}ₜₕ. This suggests that electrons involved in chemical bonding of material are released from the bond by multiphoton absorption, and damage is induced when the number (density) of these released electrons exceeds a certain fixed value. When electrons involved in bonding are released, the bond energy momentarily weakens, and distortion of the nuclear arrangement/structure occurs together with electron detachment. Then, when released electrons return again to the bonding orbital, the nuclear arrangement/structure is frozen as that distorted arrangement/structure. This is illustrated schematically in FIG. 7.

That is to say, FIG. 7 is a drawing showing schematically structural change induced by damage according to the present invention in glass. FIG. 7A shows the structure of glass before laser irradiation, and FIG. 7B shows the structure of glass after laser irradiation. In FIG. 7A the glass has a regular structure/arrangement, and in FIG. 7B the structure/arrangement of the glass is frozen in a greatly distorted form. This kind of structural change resembles a metal-dielectric phase transition. Therefore, damage (density/refractive index modification) according to the present invention is thought to be caused by this kind of mechanism.

### EXPERIMENT 4

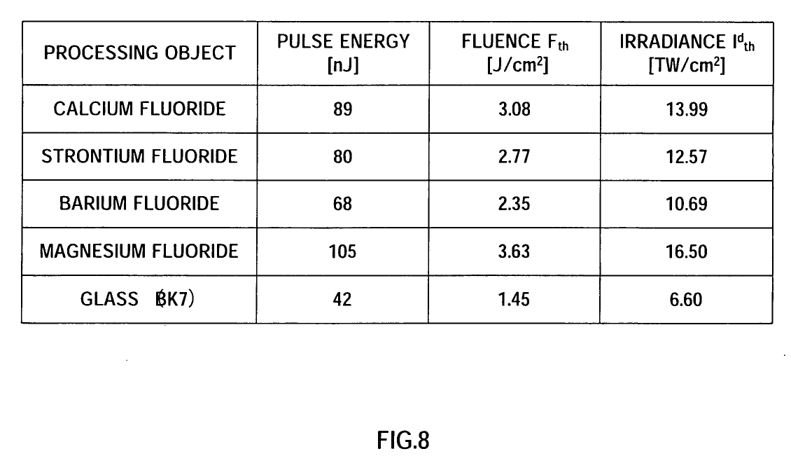

In Experiment 4, the laser intensity threshold of damage according to the present invention was measured for various processing objects. That is to say, it is of course possible for damage according to the present invention to be caused in dielectric materials other than the above-mentioned glass. Using a pulsed laser with a numerical aperture (NA) of 1.07, an 800 nm wavelength, and a 220 fs pulse width, the laser intensity threshold (pulse energy/fluence/irradiance) for causing damage was measured using the apparatus in FIG. 1. FIG. 8 shows the results for a number of dielectrics, including calcium fluoride (CaF₂), strontium fluoride (SrF₂), barium fluoride (BaF₂), magnesium fluoride (MgF₂), and BK7 glass (SiO₂), for example. The present method is thus seen to be a highly versatile technique applicable to various kinds of solid materials.

Thus, according to the present invention, extremely minute damage (modification) of a size not exceeding half the laser wavelength diffraction limit value can be caused in a variety of dielectric materials and semiconductor materials, without inducing plasma. Such damage can be induced at an arbitrary location inside a processing object by flexibly changing the focal point location.

At this time, this damage is manifested as refractive index modification, and can therefore be read optically. Therefore, if such a minute damage spot is used as a void for optical memory, two-dimensional/three-dimensional memory with storage density improved by an order of magnitude or more compared with the prior art can be created with a variety of solid materials.

Also, by forming damage according to the present invention arbitrarily in a solid material, it is possible to perform fine marking in a variety of materials.

Furthermore, as damage according to the present invention also induces density modification, such damage also forms a starting point of material cutting. If damage is arranged along a predetermined cutting line, a solid material can be cut with sub-micrometer processing accuracy.

Thus, the present invention provides a highly versatile technology that enables extremely minute damage of 100 to 200 nm, or less than 100 nm, to be implemented in various kinds of material without inducing plasma.

The present application is based on Japanese Patent Application No. 2004-156768 filed on May 26, 2004, the entire content of which is expressly incorporated by reference herein.

### INDUSTRIAL APPLICABILITY

A laser processing method and apparatus according to the present invention are effective as a laser processing method and apparatus capable of inducing extremely minute damage (modification) of a size not exceeding half the laser wavelength diffraction limit value in a variety of dielectric materials and semiconductor materials, without inducing plasma.

1. A laser processing method wherein convergent irradiation of a processing object is performed via an optical system with a laser beam that has laser intensity smaller than a laser intensity threshold at which plasma is caused in the processing object, and damage is caused without causing plasma in the processing object.

2. The laser processing method according to claim 1, wherein the laser beam has laser intensity determined using a characteristic curve such that, in a relationship between an irradiance threshold of damage occurrence of the processing object and laser pulse width, the irradiance threshold does not depend on laser pulse width, but has a unique fixed value for the processing object.

3. The laser processing method according to claim 1, wherein the laser beam has laser intensity determined using a characteristic curve such that, in a relationship between a fluence threshold of damage occurrence of the processing object and laser pulse width, the fluence threshold is monotonically proportional to laser pulse width.

4. The laser processing method according to claim 1, wherein the laser beam has laser intensity not exceeding 1/1.5 of a laser intensity threshold at which plasma is caused in the processing object.

5. The laser processing method according to claim 2, wherein the optical system is set so that a self-focusing effect is not caused at a convergence location of the laser beam.

6. The laser processing method according to claim 5, wherein:
the optical system comprises an objective lens; and
the objective lens has a numerical aperture that does not cause a self-focusing effect at a convergence location of the laser beam.

7. The laser processing method according to claim 6, wherein the objective lens is a lens whose numerical aperture NA>1.

8. The laser processing method according to claim 5, wherein:
the optical system comprises an objective lens; and
the laser beam is introduced into the objective lens after a beam diameter is enlarged.

9. The laser processing method according to claim 1, wherein the laser beam is convergently radiated into the processing object after being shaped to a predetermined beam cross-sectional shape, scattered light from the processing object is detected via a predetermined aperture, and the damage is detected.

10. The laser processing method according to claim 9, wherein, during processing, the laser beam shaped to a predetermined beam cross-sectional shape is convergently radiated into the processing object, and the damage is detected by detecting scattered light from the processing object via a predetermined aperture during processing.

11. The laser processing method according to claim 9, wherein, after processing, the laser beam shaped to a predetermined beam cross-sectional shape is convergently radiated into the processing object, and the damage is detected by detecting scattered light from the processing object via a predetermined aperture after processing.

12. The laser processing method according to claim 1, wherein a pulse width of the laser beam is in a range of 10 femtoseconds to 100 nanoseconds.

13. A laser processing apparatus comprising:
a laser beam generation section that generates a laser beam that has laser intensity smaller than a laser intensity threshold at which plasma is caused in a processing object; and
an optical system that convergently radiates the laser beam into the processing object, wherein:
laser intensity of the laser beam is determined using a characteristic curve such that, in a relationship between an irradiance threshold of damage occurrence of the processing object and laser pulse width, the irradiance threshold does not depend on laser pulse width, but has a unique fixed value for the processing object; and
the optical system is set so that a self-focusing effect is not caused at a convergence location of the laser beam.

14. A laser processing apparatus comprising:
a laser beam generation section that generates a laser beam that has laser intensity smaller than a laser intensity threshold at which plasma is caused in a processing object; and
an optical system that convergently radiates the laser beam into the processing object, wherein:
laser intensity of the laser beam is determined using a characteristic curve such that, in a relationship between a fluence threshold of damage occurrence of the processing object and laser pulse width, the fluence threshold is monotonically proportional to laser pulse width; and
the optical system is set so that a self-focusing effect is not caused at a convergence location of the laser beam.

15. The laser processing apparatus according to claim 13, wherein the laser beam has laser intensity not exceeding 1/1.5 of a laser intensity threshold at which plasma is caused in the processing object.

16. The laser processing apparatus according to claim 13, wherein: the optical system, comprises an objective lens; and the objective lens is a lens whose numerical aperture NA>1.

17. The laser processing apparatus according to claim 13, wherein the optical system comprises: an objective lens; and a telescopic optical system that enlarges a beam diameter of the laser beam between the laser beam generation section and the objective lens.

18. The laser processing apparatus according to claim 13, wherein a pulse width of the laser beam is in a range of 10 femtoseconds to 100 nanoseconds.
